(19) United States
(12) Patent Application Publication
(10) Pub. No.: US 2003/0011294 A1
(43) Pub. Date: Jan. 16, 2003

(54) Cathode ray tube employing a cathode structure having improved gamma characteristics

(76) Inventors: Toshifumi Komiya, Mobara (JP); Sachio Koizumi, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/189,469

(22) Filed: Jul. 8, 2002

(30) Foreign Application Priority Data
Jul. 11, 2001 (JP) 2001-211085

(51) Int. Cl. H01J 29/04; H01J 29/48

(52) U.S. Cl. 313/454; 313/446

(57) ABSTRACT

A cathode ray tube has an electron beam generating section including an indirectly heated cathode structure and first and second electrodes arranged in the order named. The cathode structure is composed of a cathode sleeve for housing a heater therein, a cathode base metal disposed at an end of the cathode sleeve facing toward the first electrode, and an electron emissive oxide layer disposed on the cathode base metal. The electron emissive oxide layer is formed with a depression on a surface thereof facing the electron beam transmissive aperture in the first electrode. A maximum diameter of the depression is smaller than a maximum diameter of the electron beam transmissive aperture in the first electrode, and a maximum depth of the depression is smaller than the maximum diameter of the depression.

### BACKGROUND OF THE INVENTION

The present invention relates to a cathode ray tube, and in particular, to a cathode ray tube capable of producing large changes in its cathode current with small changes in its small drive voltage by improving γ characteristics of an electron beam generating section of its electron gun housed in its vacuum envelope.

Color cathode ray tubes such as color picture tubes and display tubes, which are typical cathode ray tubes, are widely used for reception of TV broadcasts or monitors in various information processing equipment because of their capability of reproducing high-definition images. Cathode ray tubes of this kind has a vacuum envelope formed of a panel, a truncated-cone-shaped funnel connected to the panel and a neck connected to a small-diameter end of the funnel, a phosphor screen formed on an inner surface of the panel, and an electron gun housed within the neck for projecting electron beams toward the phosphor screen. The color cathode ray tubes employ in-line type electron guns for projecting plural electron beams in parallel with each other in a horizontal plane toward their phosphor screens.

FIG. 6 is a schematic cross-sectional view of a shadow mask type color cathode ray tube serving as an example of cathode ray tubes to which the present invention is applicable. In FIG. 6, reference numeral 1 denotes a panel, 2 is a funnel, 3 is a neck, 4 is a phosphor layer (also referred to as a phosphor screen) coated on an inner surface of the panel 1, and 5 is a shadow mask structure.

The shadow mask structure 5 has a shadow mask 5A having a large number of electron beam transmissive apertures therein and serving as a color selection electrode and a mask frame 5B fixing the shadow mask 5A in place. A magnetic shield 5C for shielding the earth's magnetic field is attached to the electron-gun-side end of the mask frame 5B. The shadow mask structure 5 is suspended at a specified distance from the phosphor screen 4 by engaging suspension springs 5D each of which is fixed at its end to the sidewall of the mask frame 5B, with studs 5E embedded in an inner wall of a skirt portion of the panel 1. An electron gun 9 for projecting three electron beams B (only one of which is shown) in a line is housed within the neck 3. Reference numeral 8 is an external magnetic device for adjusting color purity and others, and 7 is a deflection yoke.

The electron beams B emitted from the electron gun 9 are deflected horizontally and vertically by the deflection yoke 7 mounted around the outside of a transition region between the neck 3 and the funnel 2, then pass through the electron beam transmissive apertures in the shadow mask 5A which serves as the color selection electrode, and then form an image by impinging upon the phosphor screen 4. As color television sets and color display monitors of the flat viewing screen type spread, there is a tendency for faceplates (panel glasses) of color cathode ray tubes used in them to be made flatter. The shadow mask type color cathode ray tube shown in FIG. 6 is also of the flat viewing screen type.

In FIG. 6, the outer surface of the panel 1 is approximately flat, and the inner surface of the panel 1 is concavely curved. The shadow mask 5A has a specified curved surface obtained by press-forming a shadow mask blank to generally conform to the inner surface of the panel 1. The inner surface of the panel 1 and the shadow mask 5A is curved as described above, although the outer surface of the panel 1 is approximately flat. The reason is that fabrication of the shadow mask 5 by using a press-forming technique is facilitated and its cost is reduced. In the shadow mask 5A, a main region including an apertured area formed with a large number of electron beam transmissive apertures is approximately rectangular, and radiuses of curvature along its major axis, its minor axis and its diagonal differ from each other. This is intended to secure compatibility of creation of a sense that a picture on the phosphor screen of the color cathode ray tube is flat, with maintenance of mechanical strength of the formed shadow mask. Incidentally, the major and minor axes of the main region are usually oriented horizontally and vertically, respectively.

FIG. 7 is a side view of a major portion of an electron gun for explaining an example of an in-line type electron gun used in a color cathode ray tube, viewed in a direction perpendicular to a direction of the in-line arrangement of three electron beams. In FIG. 7, reference numeral 26 denotes a cathode structure, 11 is a first electrode serving as a control grid, and 12 is a second electrode serving as an accelerating electrode. The cathode structure 26, the first electrode 11 and the second electrode 12 form an electron beam generating section. Reference numeral 13 denotes a third electrode, 14 is a fourth electrode, 15 is a fifth electrode. In this example, the third, fourth and fifth electrodes 13, 14, 15 form a first-stage lens. Reference numeral 16 denotes a sixth electrode, which forms a second-stage lens in cooperation with the fifth electrode 15. Reference numeral 17 denotes a shield cup which is welded to the sixth electrode 16. The above-described electrodes are fixed on a pair of insulating support members (multiform glasses) 20 in the specified order and a specified spaced relationship. Reference numeral 19 denote spring members which contact a conductive film coated on the inner surface of the vacuum envelope (not shown) and thereby supplies a high voltage to an electrode constituting the second-stage lens of the electron gun.

In FIG. 7, reference numeral 18 denotes a stem having stem pins 18A sealed therethrough. Display signals and operating voltages are applied to the electron gun via the stem pins 18A from a circuit external to the color cathode ray tube.

A triode section comprising the cathode structure 26, the first electrode 11 and the second electrode 12 forms an electron beam generating section. The three electron beams emitted from the electron beam generating section are focused and accelerated by third, fourth and fifth electrodes 13, 14, 15, then are focused appropriately and directed toward the phosphor screen by the second-stage lens formed between opposing faces of the fifth and sixth electrodes 15, 16.

### SUMMARY OF THE INVENTION

One of applications of color cathode ray tubes for use in high definition monitors (hereinafter color display tubes and sometimes called CDTS) is viewing a movie on a color cathode ray tube by playing a DVD (Digital Versatile Disc) on a personal computer, for example. There have been increasing opportunities of recording television programs on a personal computer and viewing them on its monitor at a later time. A deflection frequency for color cathode ray tubes used in the monitors of this kind is higher than that for ordinary color TV picture tubes (sometimes called CPTs).

For reproduction of images having high contrast ratio as in the case of using the ordinary color TV picture tubes, it is necessary to control cathode currents by using large signal voltages as in the case of color TV receivers. This requires a circuit specially designed for increasing signal voltages at high frequencies used in display monitors of personal computers, and increases the cost of the monitors. Consequently, cathode ray tubes are needed which are capable of swinging cathode currents to levels producing high brightness with small changes in signal voltages at the high frequencies as in the case where the ordinary color TV picture tubes are driven in the color TV receivers.

The small-voltage drive can be realized by increasing steepness of the slope (the so-called γ value) of the logarithmic plot of the drive characteristic of the color display tubes, and the γ value depends mainly upon geometry of electrodes of an electron gun. Acathode current of a cathode ray tube is expressed by the following equation:

A cathode current=(a constant)×(the γ th power of a drive voltage).

Usually the γ value is approximately 2.8. It is difficult to increase the γ value by using conventional specifications of electrodes and cathodes for an electron gun.

There are market needs for display devices capable of reproducing sufficiently-high-contrast moving pictures having the image quality of color TV picture tubes, on a color display tube by obtaining large changes in cathode currents with small changes in drive voltages. As a matter of course, reduction in drive voltages results in lowering of the cost of the monitor circuit.

Conventional techniques related to changing of cathode currents in cathode ray tubes of this kind are disclosed in Japanese Patent Application Laid-Open No. Hei 7-176,262, Japanese Patent Application Laid-Open No. Hei 7-249,366, and a Japanese Edition, volume 1, p. 112, of Watson, G: “Basic Electronic Engineering,” translated by Kenzo Yamamoto and published by Hirokawa Publishing Company (Tokyo, Japan)

Japanese Patent Application Laid-Open No. Hei 7-176,262 discloses a technique related to a cathode of the impregnated type which improves a focus characteristic by making a surface of the cathode facing the first electrode convex toward the first electrode, thereby reducing the size of the electron emitting area, and consequently reducing the diameter of electron beam spots on the phosphor screen. But in this technique, no consideration is given to γ characteristics.

Japanese Patent Application Laid-Open No. Hei 7-249,366 discloses a technique related to a cathode of the impregnated type which prevents contamination by gases by depressing a central area of a surface of the cathode facing an electron beam transmissive aperture in the first electrode. But in this technique, no consideration is given to γ characteristics.

In the “Basic Electronic Engineering,” the Pierce electron gun for use in the microwave frequency range is described. In the Pierce electron gun, an electron beam is focused by a beam-forming electrode making an angle of 67.5 degrees with respect to a direction of emergence of outermost rays of the electron beam. This beam-forming electrode corresponds to the first electrode, and its electron beam aperture is smaller in area than the electron emitting area of the cathode surface, and the electron beam is focused between the cathode and the beam-forming electrode. Since the beam-forming electrode is disposed adjacently to the end of the cathode and is inclined at the angle of 67.5 degrees as described above, latitude in the design of the electron gun is greatly reduced due to limitations associated with a spacing between the cathode and the beam-forming electrode. Provision of such an electrode increases the cost of the electron gun. Consequently, such a beam-forming electrode is not employed in color picture tubes or color display tubes.

It is an object of the present invention to provide a cathode ray tube capable of producing images having sufficiently high contrast ratio with small drive voltages by increasing the γ value, in view of the above-explained technical background.

In a small-current operating condition, a cathode current is provided from a central portion of a cathode, and in a large-current operating condition, a cathode current is provided from an area expanded toward the periphery of the cathode. Usually the electron emitting diameters of a cathode are about 5% and about 70% of a diameter of an electron beam transmissive aperture in the first electrode of an electron beam generating section in the small-current and large-current operating conditions, respectively.

The γ value can be increased by making a distance from an electron emissive portion of the cathode facing a peripheral portion of an electron beam transmissive aperture in the first electrode to the electron beam transmissive aperture shorter than a distance from an electron emissive portion of the cathode facing a central portion of the electron beam transmissive aperture to the electron beam transmissive aperture.

If the central portion of the cathode is shaped so as to be farther from the first electrode than the peripheral portion of the cathode is from the first electrode, then, as the cathode current is increased, electrons begin to be extracted from the peripheral portion easy for electrons to be extracted, that is, the portion for electric fields to easily enter. As a result, even when a current in the small-current operating condition is equal to that in conventional cathodes, a current can be increased in the large-current operating condition compared with that in the conventional cathodes, and consequently, the γ value is increased.

The present invention has been made in consideration of the above-explained fact, and the following explains the representative configurations of the present invention for accomplishing the above-mentioned object.

In accordance with an embodiment of the present invention, there is provided a cathode ray tube having: a vacuum envelope including a panel, a neck and a funnel connecting the panel and the neck; a phosphor screen formed on an inner surface of the panel; an electron gun housed within the neck; and a deflection yoke mounted around a transition region between the funnel and the neck; the electron gun comprising: an electron beam generating section including an indirectly heated cathode structure and first and second electrodes arranged in the order named, each of the first and second electrodes having an electron beam transmissive aperture for passing an electron beam from the indirectly heated cathode structure; and a plurality of electrodes for focusing and accelerating the electron beam from the electron beam generating section toward the phosphor screen, wherein the indirectly heated cathode structure comprises a generally cylindrical cathode sleeve for housing a heater therein, a cathode base metal disposed at an end of the cathode sleeve facing toward the first electrode, and an electron emissive oxide layer disposed on a surface of the cathode base metal facing toward the first electrode, the electron emissive oxide layer is formed with a depression on a surface thereof facing the electron beam transmissive aperture in the first electrode, a maximum diameter of the depression is smaller than a maximum diameter of the electron beam transmissive aperture in the first electrode, and a maximum depth of the depression is smaller than the maximum diameter of the depression.

The present invention is not limited to the above-described configurations, and it is needless to say that various changes and modifications can be made to the above configurations without departing from the nature and spirit of the present invention.

### BRIEF DESCRIPTION OF THE DRAWINGS

In the accompanying drawings, in which like reference numerals designate similar components throughout the figures, and in which:

FIG. 1 is a cross-sectional view of major components of an electron emissive area and its vicinity of a cathode structure for explaining a first embodiment in accordance with the present invention;

FIG. 2 is a cross-sectional view of an example of a configuration employing a cathode structure incorporating the electron emissive area shown in FIG. 1;

FIG. 3 is a graph showing a comparison in γ characteristic between an electron gun structure of a first embodiment of the present invention and a conventional electron gun structure having a flat electron emissive cathode surface;

FIG. 4 is a schematic cross-sectional view of an electron emissive area and its vicinity of a cathode structure for explaining another embodiment in accordance with the present invention;

FIGS. 5A to 5C are schematic cross-sectional views of electron emissive areas and their vicinities of cathode structures for explaining other embodiments in accordance with the present invention, respectively;

FIG. 6 is a schematic cross-sectional view of a shadow mask type color cathode ray tube serving as an example of cathode ray tubes to which the present invention is applicable; and

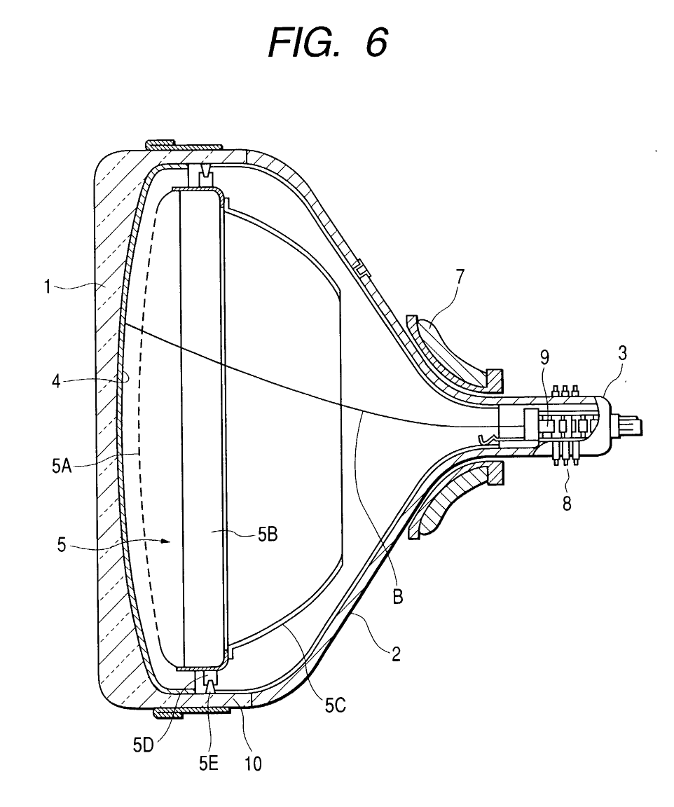

FIG. 7 is a side view of a major portion of an electron gun for explaining an example of an in-line type electron gun used in a color cathode ray tube.

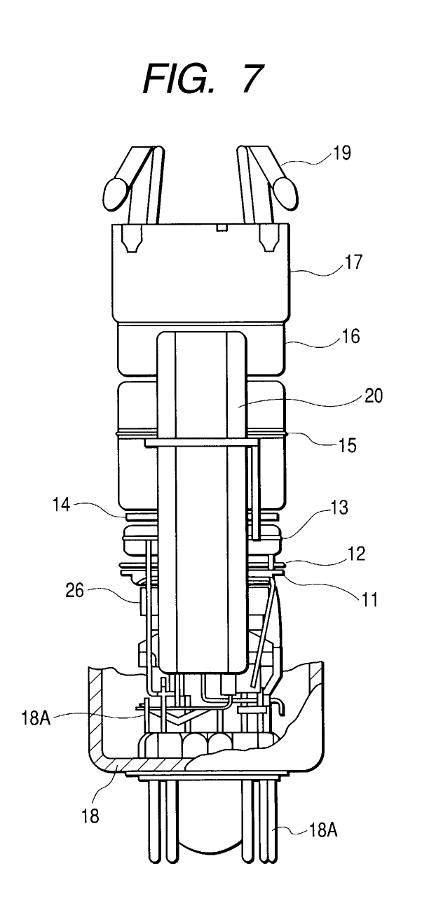

### DETAILED DESCRIPTION OF THE PREFERRED EMBODIMENTS

The embodiments in accordance with the present invention will now be explained in detail by reference to the drawings.

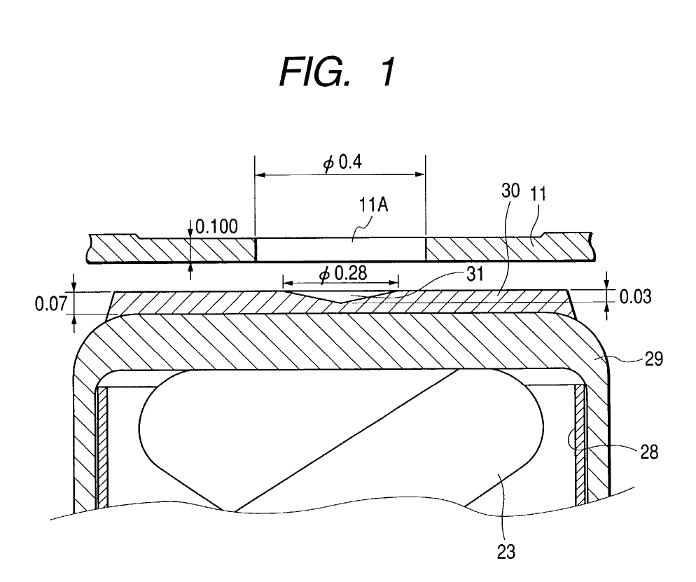

FIG. 1 is a cross-sectional view of major components of an electron emissive area and its vicinity of a cathode structure for explaining a first embodiment in accordance with the present invention. In this embodiment, the present invention is applied to a cathode structure using an oxide layer as an electron emissive material layer. Reference numeral 28 denotes a cathode sleeve, 29 is a cathode base metal. The carbonate layer 30 is coated on a surface of the cathode base metal 29 disposed at an end of the cathode sleeve 28 facing toward the first electrode 11, and the carbonate layer 30 is made of a carbonate material containing at least Ba, and is converted into the electron emissive material layer in a subsequent activation and aging process. A heater 23 is housed within the cathode sleeve 28.

In this embodiment, a depression 31 is formed in a surface of the carbonate layer 30 just under an electron beam transmissive aperture 11A in the first electrode 11. The depression 31 is cone-shaped with its wall sloped toward a center of the bottom of the depression 31. Dimensional examples are indicated in FIG. 1. By way of example, consider that a diameter of the electron beam transmissive aperture 11A in the first electrode 11 is 0.4 mm, the thickness of the first electrode 11 at the edge of the aperture 11A is 0.10 mm, and a thickness of the carbonate layer 30 is 0.07 mm. The diameter and the maximum depth of the depression 31 are selected to be 0.28 mm and 0.03 mm, respectively. Here the diameter and the maximum depth of the depression 31 is 70% of that of the electron beam transmissive aperture 11A in the first electrode 11, and the maximum depth of the depression 31 is 43% of the thickness of the carbonate layer 30.

In the cathode formed with the depression 31, in a small-current operating condition, a cathode current is extracted mainly from a central portion of the depression 31, and as the drive voltage is increased, an electron emitting area expands toward the periphery of the depression 31. The peripheral portion of the depression 31 is nearer to the first electrode 11, and as a result, an apparently larger drive voltage is applied to the peripheral portion than in the case of a conventional flat-surface cathode. Consequently, a small change in the drive voltage produces a large change in the cathode current, and as a result, the γ value is increased.

In the oxide layer formed from the carbonate layer, the preferable ratio of the maximum diameter of the depression to the maximum diameter of the electron beam transmissive aperture in the first electrode is in a range from 0.2 to 0.9. If the above ratio is smaller than 0.2, the depression has little effect on the γ characteristics in a small-current operating condition of the cathode current of several tens of microamperes. In the practical operating condition, the diameter of the electron-emitting area of the cathode from which as much as 1 mA of the cathode current is extracted is equal to or smaller than 90% of the maximum diameter of the electron beam transmissive aperture in the first electrode. If the above ratio is selected to be greater than 0.9, a portion of the oxide layer outside the depression needs to be placed closer to the first electrode, and consequently, this increases the possibility of short circuit between the oxide layer and the first electrode.

Here the terms “the maximum diameter of the electron beam transmissive aperture in the first electrode” and “the maximum diameter of the depression” are used because the electron beam transmissive aperture and the depression are not always circular in a plan view.

In the oxide layer formed from the carbonate layer, the preferable ratio of the maximum depth of the depression to the thickness of the oxide layer is in a range from 0.3 to 0.85. If this ratio is smaller than 0.3, electron emission efficiency is relatively insufficient in a large-current operating condition. On the other hand, if this ratio is greater than 0.85, electron emission efficiency is relatively insufficient in a small-current operating condition.

In oxide cathodes using an oxide layer as an electron emissive layer, the thickness of the oxide layer is considerably small, and therefore the maximum depth of the depression is configured to be smaller than the maximum diameter of the depression.

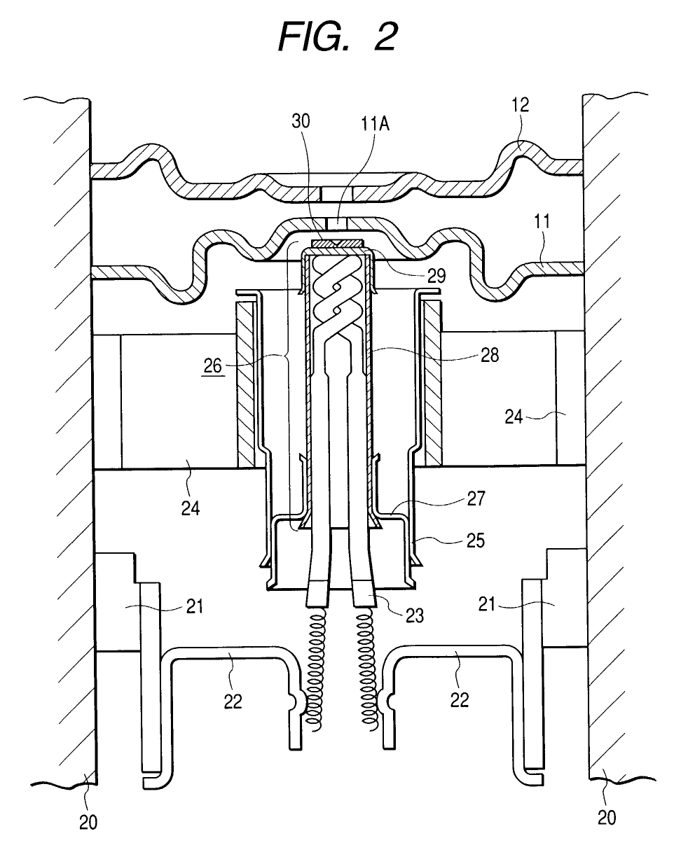

FIG. 2 is a cross-sectional view of an example of a configuration employing a cathode structure incorporating the electron emissive area shown in FIG. 1. In FIG. 2, reference numeral 20 denote bead glasses, 21 are heater lead straps, 22 are heater supports, 23 is a heater, 24 are cathode supports, 25 is a cathode support eyelet, 26 is a cathode structure, 27 is a cathode cylinder, 28 is the cathode sleeve, 29 is the cathode base metal, and 30 is the carbonate layer which is converted into the oxide layer serving as the electron emissive material layer in the subsequent process step.

The cathode structure 26 is fixed to the cathode support eyelet 25 via the cathode cylinder 27, and the cathode support eyelet 25 is fixed to the bead glasses 20 via the cathode supports 24. The heater 23 housed within the cathode sleeve 28 are welded at its two ends (two terminal portions) to the respective heater supports 22 fixed to the heater lead straps 21 one end of each which is embedded into the respective bead glasses 20. The first electrode 11 is fixed at a specified distance from the carbonate layer 30 of the cathode structure 26 by embedding peripheral portions of the first electrode 11 into the bead glasses 20, and likewise the second electrode 12 is fixed at a specified distance from the first electrode 11 by embedding peripheral portions of the second electrode 12 into the bead glasses 20. The cathode structure 26, the first electrode 11 and the second electrode 12 form an electron beam generating section (a so-called triode section). The configuration of the carbonate layer 30 coated on the cathode base metal 29 is as explained in connection with FIG. 1.

The following explains a method of forming the depression 31 in the carbonate layer 30 coated on the cap-shaped cathode base metal 29. Initially prepared is the cathode structure 26 having the cathode base metal 29 having its outer surface coated with a carbonate material (for example, triple carbonates containing Ba, Sr, and Ca carbonates) from which the oxide layer (for example, a BaO+SrO+CaO oxide layer) is formed, and then the cathode structure 26 is fixed to the cathode eyelet 25. Next, a jig having a tip contoured to conform to the contour of the surface of the depression 31 is guided through the electron beam transmissive aperture 11A formed in the first electrode 11 by the aperture 11A, and then the depression 31 is formed by pressing the carbonate layer 30. The maximum diameter of the cone-shaped tip of the jig is selected to be approximately 0.28 mm which is equal to the maximum diameter of the cone-shaped depression 31. In this way the depression 31 is formed in the surface of the carbonate layer 30 such that the depression 31 is coaxial with the electron beam transmissive aperture 11A formed in the first electrode 11.

The shape of the depression 31 formed in this way is retained even after the carbonate layer 30 has been converted into an oxide layer by heating the carbonate layer 30 in vacuum and removing carbon dioxide therefrom.

The thickness of the oxide layer formed from the carbonate layer 30 is about 70% of that of the original carbonate layer 30, but the diameter of the depression 31 in the oxide layer remains nearly unchanged. The density in the pressed portion is increased, and therefore the thickness of the pressed portion does not change easily. Completed cathode ray tubes were disassembled and investigated which utilized the carbonate layer shaped in the form explained in connection with FIG. 1, and which had been subjected to the cathode activation and aging process, and it was confirmed that the thickness of the oxide layer formed from the carbonate layer 30 was about 0.05 mm, the maximum diameter of the depression 31 was about 0.28 mm, and the depth of the depression 31 was about 0.02 mm. The ratio of the depth of the depression 31 to the thickness of the electron emissive oxide layer was 0.4.

The foregoing is an example in which the electron beam transmissive aperture 11A in the first electrode 11 is circular, and 0.40 mm in diameter, and the depression formed in the electron emissive material layer is cone-shaped with its wall sloped toward a center of the bottom of the depression. The present invention is applicable to color display tubes (CDTs) employing oxide cathodes, and it is needless to say that the present invention is applicable to the following dimensions and operating conditions of electron guns:

diameter of a circular electron beam transmissive aperture or length of one side of a rectangular electron beam transmissive aperture in the first electrode 11 is in a range from 0.35 mm to 0.45 mm;

spacing between an electron emissive surface of the cathode and the first electrode 11 in normal operation is in a range from 0.03 mm to 0.06 mm;

thickness of the first electrode 11 at the edge of the electron beam transmissive aperture 11A in the first electrode 11 is in a range from 0.008 mm to 0.012 mm;

the second electrode is supplied with a voltage of about 600 V; and

an electron beam-cutoff cathode voltage is in a range from 80 V to 130 V.

In this embodiment, the γ value in the electron gun structure is increased, and thereby small changes in drive voltages produce great changes in brightness of images on the viewing screen. Consequently, the present invention provides low-cost cathode ray tubes capable of producing images having sufficient contrast ratio.

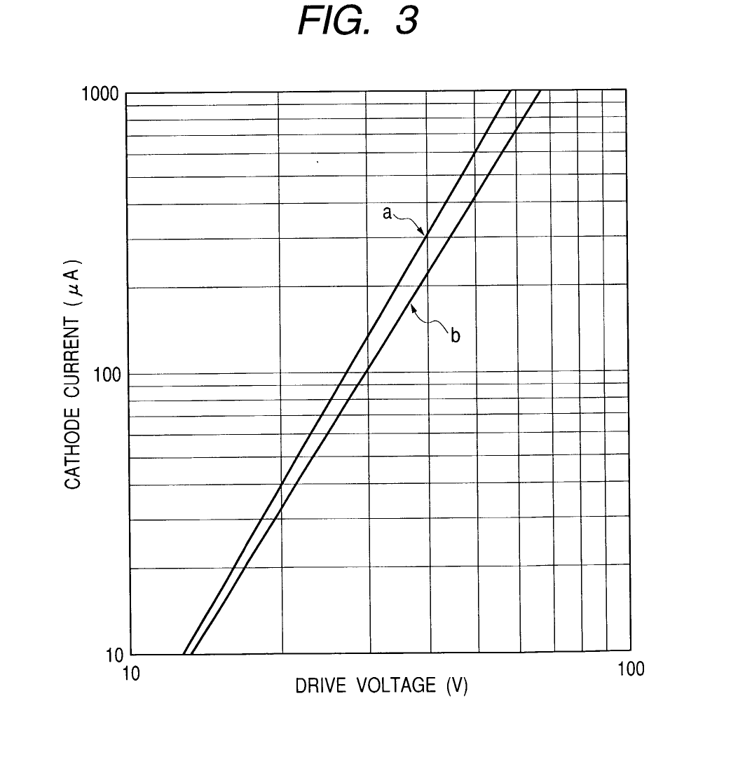

FIG. 3 is a graph showing a comparison in γ characteristic between the electron gun structure of the first embodiment of the present invention and a conventional electron gun structure having a flat electron emissive cathode surface. The abscissas represent drive voltages and the ordinates represent cathode currents when a cathode voltage is gradually decreased from a cathode cutoff voltage. The two 51-cm-diagonal-screen monitor-use cathode ray tubes incorporating the gun structure of this embodiment and the conventional gun structure, respectively, were operated with an anode voltage of 27.5 kV, a focus electrode voltage of about 7.7 kV, and a first-electrode voltage of 0 V. Second-electrode voltages for the two cathode ray tubes were adjusted in the vicinity of 600 V to provide the same cathode cutoff voltage of 110 V, respectively, so as to eliminate a difference in cutoff voltage between the two cathode ray tubes due to fabrication variations. Drive voltages are voltages actually applied to the cathode minus the cathode cutoff voltage of 110 V. FIG. 3 shows comparison in cathode current between the two cathode ray tubes by the logarithmic plot of cathode current versus drive voltage when the cathode voltage is gradually reduced from the cutoff voltage. Curve a in FIG. 3 shows a γ characteristic of the electron gun structure employing a cathode formed with the depression in accordance with the present invention, and curve b shows a γ characteristic of the conventional electron gun structure employing a flat-surface cathode. It is apparent from this comparison that the formation of the depression in the cathode surface produces great changes in cathode current with small changes in drive voltages.

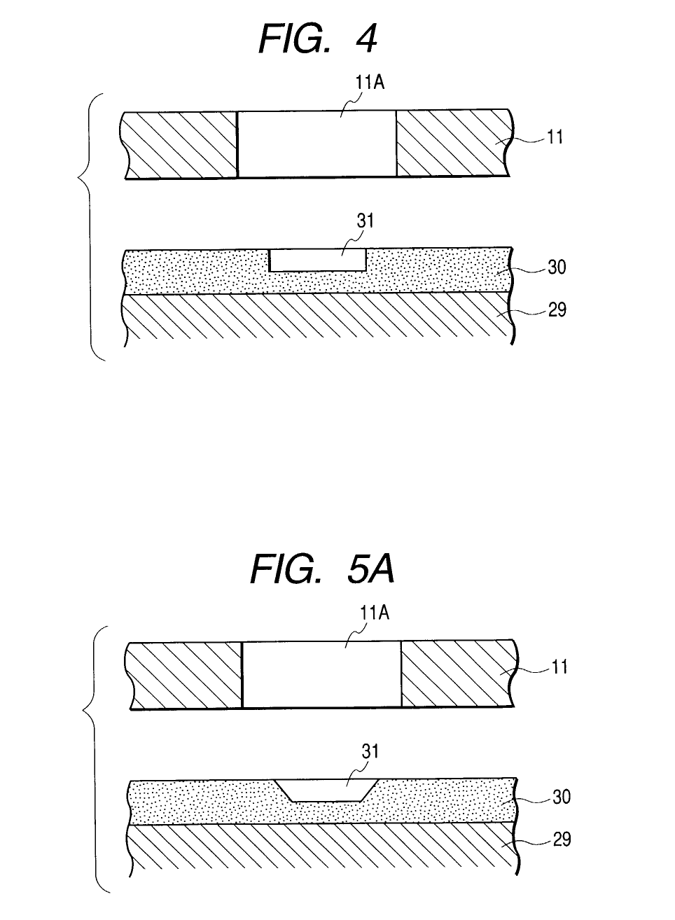

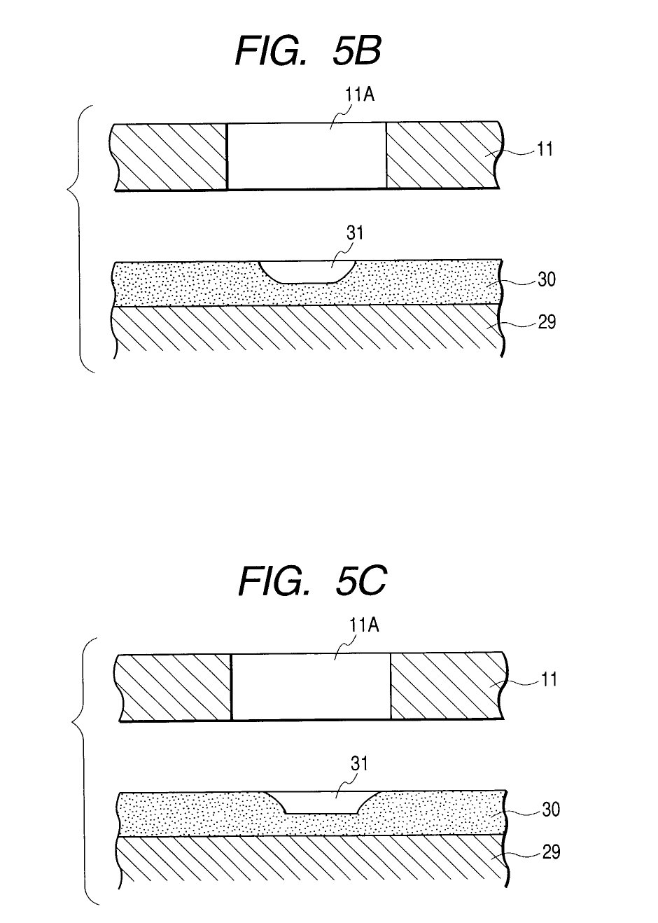

FIGS. 4 and 5A-5C are cross-sectional views of electron emissive areas and their vicinities of cathode structures for explaining other embodiments in accordance with the present invention, respectively. In mass production of the cathode ray tubes in accordance with the present invention, it is not easy to position the central axis of the depression 31 with the central axis of the electron beam transmissive aperture 11A in the first electrode 11 with accuracy. In an embodiment shown in FIG. 4, the depression 31 formed in the carbonate layer 30 is provided with a flat bottom so that assembling errors of the electrodes are absorbed and thereby the advantages are highly reproducible. In this case, since it is necessary to extract sufficient currents from the outside of the depression 31 also in a large-current operating condition, the area of the depression 31 (in a plan view) needs to be made smaller than that (in a plan view) in the case explained in connection with FIG. 1. It is preferable that the maximum diameter of the depression 31 in the oxide layer formed from the carbonate layer is selected to be equal to or smaller than 60% of the diameter of the electron beam transmissive aperture 11A, and, in other words, the area in a plan view of the depression 31 is selected to be equal to or smaller than 36% of that of the electron beam transmissive aperture 11A. In FIG. 5A, the oxide layer 30 is formed with a depression 31 having a flat bottom and its wall sloped toward a center of the flat bottom of the depression 31. The shape of the sloped wall of the depression 31 prevents the depression 31 from being distorted out of the desired shape in the depression-forming operation. In this case, however, as in the case explained in connection with FIG. 4, it is necessary to make the area of the depression 31 (in a plan view) smaller than that (in a plan view) in the case explained in connection with FIG. 1. As shown in FIG. 5B, the wall of the depression 31 can be formed as a segment of a concave, or as shown in FIG. 5C, the wall of the depression 31 can be formed as a segment of a convex. The provision of the depressions 31 shown in FIGS. 4 and 5A-5C provides the advantages similar to those obtained by the first embodiment.

The present invention is not limited to the color cathode ray tube explained in connection with the above embodiments, and the present invention is applicable to other color cathode ray tubes employing an in-line three-beam electron gun, monochrome cathode ray tubes, and other types of cathode ray tubes. The above embodiments have been explained in connection with the cathode structures of the type in which the cap-shaped base metal is fitted around the outside of the cathode sleeve, but it is needless to say that the present invention is applicable to cathode structures of the type in which a plate-shaped base metal is fitted within the cathode sleeve.

As explained above, the present invention provides a cathode ray tube capable of producing images having sufficient contrast ratios with small drive voltages by increasing the γ value of the electron gun structure.

What is claimed is:

1. A cathode ray tube having:
a vacuum envelope including a panel, a neck and a funnel connecting said panel and said neck;
a phosphor screen formed on an inner surface of said panel;
an electron gun housed within said neck; and
a deflection yoke mounted around a transition region between said funnel and said neck;
said electron gun comprising:
an electron beam generating section including an indirectly heated cathode structure and first and second electrodes arranged in the order named, each of said first and second electrodes having an electron beam transmissive aperture for passing an electron beam from said indirectly heated cathode structure; and
a plurality of electrodes for focusing and accelerating said electron beam from said electron beam generating section toward said phosphor screen,
wherein
said indirectly heated cathode structure comprises
a generally cylindrical cathode sleeve for housing a heater therein,
a cathode base metal disposed at an end of said cathode sleeve facing toward said first electrode, and
an electron emissive oxide layer disposed on a surface of said cathode base metal facing toward said first electrode,
said electron emissive oxide layer is formed with a depression on a surface thereof facing said electron beam transmissive aperture in said first electrode,
a maximum diameter of said depression is smaller than a maximum diameter of said electron beam transmissive aperture in said first electrode, and
a maximum depth of said depression is smaller than said maximum diameter of said depression.

2. A cathode ray tube according to claim 1, wherein said maximum diameter of said depression is in a range of from 20% to 90% of said maximum diameter of said electron beam transmissive aperture in said first electrode, and
said maximum depth of said depression is in a range of from 30% to 85% of a thickness of said electron emissive oxide layer, said thickness of said electron emissive oxide layer being measured in the vicinity of said depression.

3. A cathode ray tube according to claim 1, wherein a wall of said depression is sloped with respect to a longitudinal axis of said cathode ray tube.

4. A cathode ray tube according to claim 3, wherein said depression is cone-shaped.

5. A cathode ray tube according to claim 3, wherein said depression has a flat bottom.

6. A cathode ray tube according to claim 1, wherein a wall of said depression is approximately parallel with a longitudinal axis of said cathode ray tube.

7. A cathode ray tube according to claim 4, wherein said maximum diameter of said depression is in a range of from 35% to 90% of said maximum diameter of said electron beam transmissive aperture in said first electrode, and
said maximum depth of said depression is in a range of from 30% to 85% of a thickness of said electron emissive oxide layer, said thickness of said electron emissive oxide layer being measured in the vicinity of said depression.

8. A cathode ray tube according to claim 5, wherein said maximum diameter of said depression is in a range of from 20% to 60% of said maximum diameter of said electron beam transmissive aperture in said first electrode, and
said maximum depth of said depression is in a range of from 30% to 85% of a thickness of said electron emissive oxide layer, said thickness of said electron emissive oxide layer being measured in the vicinity of said depression.

9. A cathode ray tube according to claim 6, wherein said maximum diameter of said depression is in a range of from 20% to 60% of said maximum diameter of said electron beam transmissive aperture in said first electrode, and said maximum depth of said depression is in a range of from 30% to 85% of a thickness of said electron emissive oxide layer, said thickness of said electron emissive oxide layer being measured in the vicinity of said depression.

10. A cathode ray tube according to claim 2, wherein said maximum diameter of said electron beam transmissive aperture in said first electrode is in a range of from 0.35 mm to 0.45 mm.

11. A cathode ray tube according to claim 7, wherein said maximum diameter of said electron beam transmissive aperture in said first electrode is in a range of from 0.35 mm to 0.45 mm.

12. A cathode ray tube according to claim 8, wherein said maximum diameter of said electron beam transmissive aperture in said first electrode is in a range of from 0.35 mm to 0.45 mm.

13. A cathode ray tube according to claim 9, wherein said maximum diameter of said electron beam transmissive aperture in said first electrode is in a range of from 0.35 mm to 0.45 mm.
